(19) United States
(12) Patent Application Publication
(10) Pub. No.: US 2021/0332633 A1
(43) Pub. Date: Oct. 28, 2021

(54) GATE OPENING AND CLOSING ASSISTANCE DEVICE FOR VEHICLE

(71) Applicants: HYUNDAI MOTOR COMPANY, Seoul (JP); KIA MOTORS CORPORATION, Seoul (KR)

(72) Inventor: Jung Hoon PARK, Yongin-si (KR)

(73) Assignees: HYUNDAI MOTOR COMPANY, Seoul (KR); KIA MOTORS CORPORATION, Seoul (KR)

(21) Appl. No.: 16/995,398

(22) Filed: Aug. 17, 2020

(30) Foreign Application Priority Data
Apr. 27, 2020 (KR) 10-2020-0050815

(51) Int. Cl. E05F 15/53; F16F 9/02; F16F 9/38

(52) U.S. Cl. CPC E05F 15/53; F16F 9/0218; F16F 9/38; F16F 2230/0023; E05Y 2900/536; E05Y 2900/548; E05Y 2900/546

(57) ABSTRACT

A gate opening and closing assistance device for a vehicle includes: a gas lifter including a cylinder filled with a compressible material, and a cylinder rod inserted into the cylinder to slide relative to the cylinder by compression or expansion of the compressible material; an inner housing which extends in a direction in which the cylinder rod extends, has one end coupled to one end of the cylinder rod to be slid together according to the sliding of the cylinder rod, and has an inner circumferential surface in contact with the cylinder while surrounding the gas lifter from the outside; and an outer housing which extends in a direction in which the cylinder extends, has a first end coupled to one end of the cylinder, has a second end through which the inner housing inserted, and surrounds a portion or the whole of the inner housing.

### CROSS REFERENCE TO RELATED APPLICATION

The present application claims priority to and the benefit of Korean Patent Application No. 10-2020-0050815, filed on Apr. 27, 2020, the entire contents of which are incorporated herein by reference.

### FIELD

The present disclosure relates to a gate opening and closing assistance device for a vehicle.

### BACKGROUND

The statements in this section merely provide background information related to the present disclosure and may not constitute prior art.

In a typical passenger vehicle, a bonnet covering an engine room and a trunk lid covering a trunk room are rotatably mounted on a vehicle body to be opened and closed.

An opening and closing structure of the bonnet and the trunk lid is configured to have rotation constrained when a latch mounted at the end of the bonnet or the trunk lid is locked to a striker mounted on the vehicle body, and to be liftable when the latch and the striker are unlocked.

At this time, a pop-up device may be additionally coupled to the bonnet and the trunk lid so that the trunk lid may be automatically lifted to a predetermined height or to a maximum opening height when unlocked.

A gas lifter using gas pressure is widely used as the pop-up device. The gas lifter has one end connected to the trunk lid or the bonnet and the other end rotatably coupled to the vehicle body to be mounted to be compressed or extend in the longitudinal direction. Accordingly, when the bonnet or the trunk lid is closed, the internal gas is compressed, and when a locking device of the bonnet or the trunk lid is released, the gas lifter is mounted to lift the bonnet or the trunk lid by extending by expansion of the gas.

In addition, the pop-up device uses a method for opening the trunk lid through a power lifter device using a motor and link structure, and the power lifter device has a high manufacturing cost and thus is applied only to luxury vehicles.

A conventional gas lifter is formed in a housing which surrounds the outer surface of the gas lifter with a spring and covers the spring and formed to have a structure which opens the trunk lid with a pressure of the gas lifter and an elastic force of the spring.

However, when the power lifter device is applied to more economically priced vehicle models (e.g., a low-priced vehicle model or a mid-priced vehicle model), the power lifter is combined with the gas lifter such that the spring of the conventional gas lifter becomes unnecessary, and a separation space between the gas lifter and the housing is generated when the spring is removed.

### SUMMARY

The present disclosure is proposed to remove a spring included in a conventional gate opening and closing assistance device for a vehicle to be applied with a power lifter and form a rib on the inner surface of an inner housing to be manufactured in the same shape as the conventional gate opening and closing assistance device for the vehicle, thereby improving appearance and decreasing manufacturing cost.

In one form of the present disclosure, a gate opening and closing assistance device for a vehicle includes: a gas lifter which includes a cylinder which extends in a longitudinal direction of the gas lifter and is filled with a compressible material therein and a cylinder rod which extends in the longitudinal direction parallel to the cylinder, is inserted into the cylinder, and is slid with respect to the cylinder by compression or expansion of the compressible material; an inner housing which extends in a direction in which the cylinder rod extends, has one end coupled to one end of the cylinder rod to be slid together according to the sliding of the cylinder rod, and has a portion of the inner circumferential surface in contact with the cylinder while surrounding the gas lifter from the outside; and an outer housing which extends in a direction in which the cylinder extends, has one end coupled to one end of the cylinder, has the other end through which the inner housing is inserted therein, and surrounds a portion or the whole of the inner housing.

The inner housing includes: a plurality of ribs which protrudes inward from the inner circumferential surface thereof, and the ribs are in contact with a portion of the outer circumferential surface of the cylinder.

The ribs of the plurality of ribs are arranged to be spaced apart from each other at regular intervals in the circumferential direction of the inner housing.

The ribs are in surface contact with a portion of the outer circumferential surface of the cylinder.

A first inclined portion is formed on one end portion of the inner housing, and the first inclined portion is configured to have the outer diameter gradually decreased while longitudinally extending.

A second inclined portion is formed on the other end portion of the outer housing, the second inclined portion being inclined to have the inner diameter gradually decreased as longitudinally extending to correspond to the first inclined portion, and when the other end portion of the cylinder rod is located at a location corresponding to the one end of the cylinder, the outer circumferential surface of the first inclined portion and the inner circumferential surface of the second inclined portion are in surface contact with each other.

The entire inner circumferential surface of the inner housing is in surface contact with the outer circumferential surface of the cylinder at the first inclined portion.

The inner housing includes: a rib which protrudes inward from the inner circumferential surface thereof to be in contact with a portion of the outer circumferential surface of the cylinder, and the rib has a gradually shortened length which extends and protrudes outward from the first inclined portion.

A flange portion which extends in a radial direction is formed on the one end of the cylinder which is exposed to the outside of the outer housing through the outer housing.

The gate opening and closing assistance device for the vehicle according to the present disclosure may form the ribs on the inner circumferential surface of the inner housing to support a space between the inner housing and the gas lifter instead of the location of the spring of the conventional gate opening and closing assistance device for the vehicle.

In addition, the plurality of ribs may be formed to be spaced apart from each other at regular intervals along the circumferential direction of the inner housing, thereby alleviating external shock and protecting the gas lifter.

In addition, the first inclined portion formed at one end of the inner housing and the second inclined portion formed at the other end of the outer pipe may be in surface contact with each other when the gate of the vehicle is closed, thereby firmly being fixed.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective diagram illustrating a gate opening and closing assistance device for a vehicle;

FIG. 2 is a side diagram illustrating a state where a gas lifter of the gate opening and closing assistance device is opened;

FIG. 3 is a side diagram illustrating a state where the gas lifter of the gate opening and closing assistance device is closed;

FIG. 4 is a cross-sectional diagram taken along the line A-A illustrated in FIG. 2;

FIG. 5 is a cross-sectional diagram taken along the line B-B illustrated in FIG. 3 in a first exemplary form of an inner housing of the gate opening and closing assistance device;

FIG. 6 is a cross-sectional diagram taken along the line B-B illustrated in FIG. 3 in a second exemplary form of an inner housing of the gate opening and closing assistance device; and

FIG. 7 is a cross-sectional diagram taken along the line C-C illustrated in FIG. 3.

the drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Specific structural to functional descriptions of the exemplary forms of the present disclosure are only illustrated for the purpose of describing the exemplary forms according to the present disclosure, and the exemplary forms may be embodied in various forms and it should not be construed that the present disclosure is limited to the exemplary forms described in the present specification or application.

Since the exemplary forms according to the present disclosure may be variously changed and have various forms, specific exemplary forms will be illustrated in the drawings and described in detail in the present specification or application. However, it should be understood that the present disclosure includes all changes, equivalents, and substitutes included in the spirit and scope of the present disclosure.

Terms such as first and/or second may be used to describe various components, but the components should not be limited by the terms. The terms are used only for the purpose of distinguishing one component from another, and for example, without departing from the scope according to the concept of the present disclosure, the first component may be named a second component, and similarly, the second component may also be named the first component.

When a component is referred to as being “connected” or “coupled” to another component, the component may be directly connected or coupled to another component, but it should be understood that other components may also be present between the components. On the other hand, when a component is referred to as being “directly connected” or “directly coupled” to another component, it should be understood that there are no other components between the components. Other expressions which describe the relationship between the components, that is, “between” and “immediately between” or “neighboring” and “directly neighboring to” should be interpreted in the same manner.

The terminology used herein is merely for the purpose of describing exemplary forms, and is not intended to limit the present disclosure. The singular forms used herein may include plural forms, unless the phrases clearly indicate the opposite. In the present application, it may be understood that the term “comprising”, “having”, or the like specifies the presence of the characteristic, integer, step, operation, component, part, or a combination thereof described in the specification, and does not exclude the presence or addition possibility of one or more other characteristics, integers, steps, operations, components, parts or combinations thereof in advance.

Unless defined otherwise, all terms including technical terms and scientific terms used herein have the same meaning as commonly understood by those skilled in the art to which the present disclosure pertains. Commonly defined terms used are additionally interpreted to have a meaning consistent with the related technical literature and the presently disclosed contents, and are not interpreted in an ideal or very formal sense unless defined.

Hereinafter, the present disclosure will be described in detail by explaining exemplary forms of the present disclosure with reference to the accompanying drawings. The same reference numerals in each drawing denote the same members.

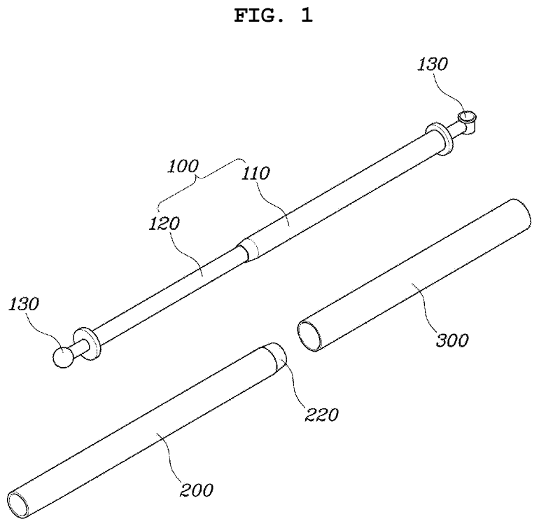

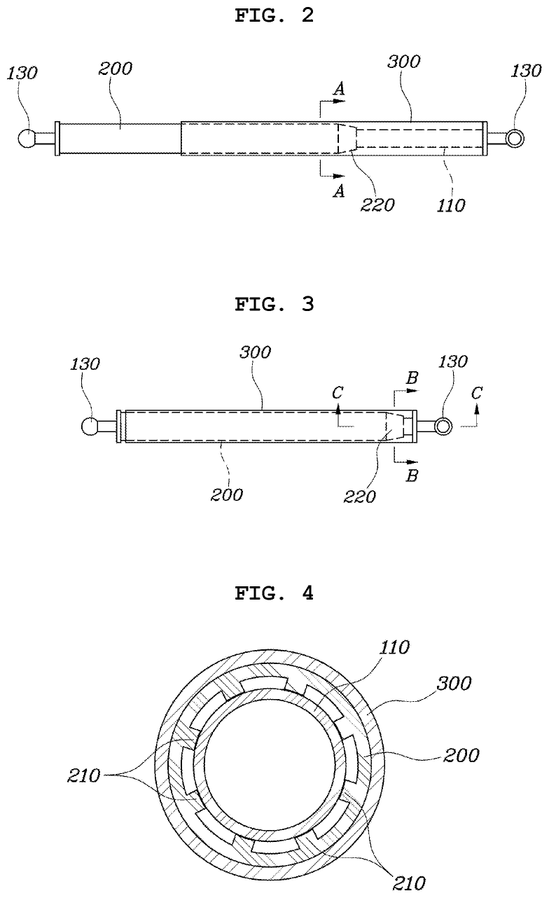

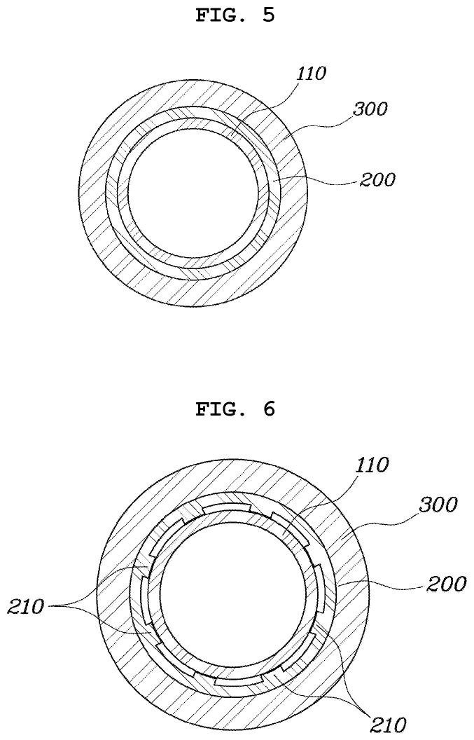

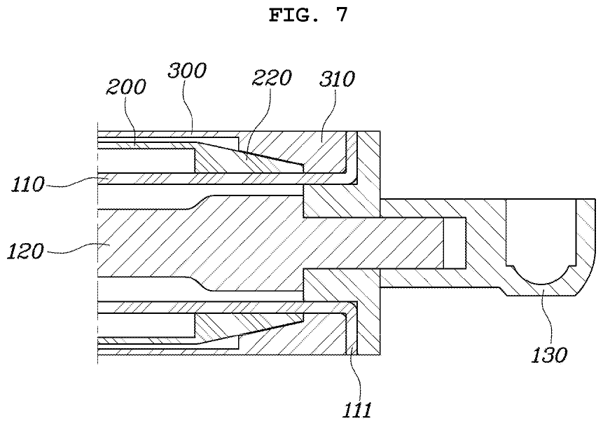

FIG. 1 is a perspective diagram illustrating a gate opening and closing assistance device for a vehicle according to an exemplary form of the present disclosure. FIG. 2 is a side diagram illustrating a state where a gas lifter of the gate opening and closing assistance device is opened according to an exemplary form of the present disclosure. FIG. 3 is a side diagram illustrating a state where the gas lifter of the gate opening and closing assistance device is closed in another form of the present disclosure. FIG. 4 is a cross-sectional diagram taken along the line A-A illustrated in FIG. 2. FIG. 5 is a cross-sectional diagram taken along the line B-B illustrated in FIG. 3 in a first exemplary form of an inner housing of the gate opening and closing assistance device for the vehicle according to an exemplary form of the present disclosure. FIG. 6 is a cross-sectional diagram taken along the line B-B illustrated in FIG. 3 in a second exemplary form of an inner housing of the gate opening and closing assistance device for the vehicle according to an exemplary form of the present disclosure. FIG. 7 is a cross-sectional diagram taken along the line C-C illustrated in FIG. 3.

Exemplary forms of a gate opening and closing assistance device for a vehicle according to the present disclosure will be described with reference to FIGS. 1 to 7.

In one form of the present disclosure, a gate opening and closing assistance device for a vehicle may be coupled between a vehicle body and a bonnet or the vehicle body and a tailgate to assist in opening or closing the bonnet at the front of the vehicle or the tailgate at the rear thereof.

The gate opening and closing assistance device may assist the opening of the gate by hydraulic pressure, and allow the gate not to quickly be closed even when the gate is closed, thereby preventing a passenger from being injured when the gate is closed. In the gate opening and closing assistance device for the vehicle, hydraulic pressure is generated by a compressible material such as gas or oil.

The gate opening and closing assistance device for the vehicle may be mounted to assist a power lifter which uses an electric motor to open and close a gate electrically.

In one form, the gate opening and closing assistance device includes: a gas lifter 100 including a cylinder 110 which extends in the longitudinal direction of the gas lifter and is filled with a compressible material therein, and a cylinder rod 120 which extends in the longitudinal direction of the gas lifter 100, is inserted into the cylinder 110, and is slid relative to the cylinder 110 by compression or expansion of the compressible material; an inner housing 200 which extends in a direction in which the cylinder rod 120 extends, has one end coupled to one end of the cylinder rod 120 to be slid according to the sliding of the cylinder rod 120 together, and has a portion of the inner circumferential surface in contact with the cylinder 110 while surrounding the gas lifter 100 from the outside; and an outer housing 300 which extends in the direction in which the cylinder 110 extends, and surrounds a portion or the whole of the inner housing 200. The outer housing includes: a first end coupled to one end of the cylinder 110, and a second end through which the inner housing 200 is inserted.

Further referring to FIG. 1, the gas lifter 100 may include the cylinder 110 which extends in the longitudinal direction, and has the compressible material inserted therein, and the cylinder rod 120 which is slid by expansion or compression of the compressible material.

When the gate lifter 100 opens the gate of the vehicle, the compressible material expands to slide the cylinder rod 120 to assist in opening the gate of the vehicle. In addition, when a power lifter opens the gate of the vehicle using an electric motor to open the gate of the vehicle, the gas lifter 100 may assist the power lifter to open the gate.

In addition, when the gas lifter 100 closes the gate of the vehicle, the compressible material may be compressed to slide the cylinder rod 120 to assist in closing the gate of the vehicle, and the gas lifter 100 may assist the gate which is quickly closed, thereby decreasing the possibility of injury to the passenger who closes the gate of the vehicle.

The inner housing 200 extends in the direction in which the gas lifter 100 extends, and may have one end coupled to one end of the cylinder rod 120 so that the cylinder rod 120 may be integrally slid when sliding, a portion of the inner circumferential surface of the inner housing 200 may be in contact with and supported by the outer circumferential surface of the cylinder 110, and the inner housing 200 may cover the gas lifter 100.

The outer housing 300 extends in the direction in which the gas lifter 100 extends, has one end coupled to one end of the cylinder 110, and is formed to surround the inner housing 200. When the other end of the cylinder rod 120 is located at a location corresponding to one end of the cylinder 110, the outer housing 300 surrounds the inner housing 200, and may cover the cylinder 110 which is exposed when the compressible material of the gas lifter 100 expands and the cylinder rod 120 and the inner housing 200 are slid.

As a result, it is possible to protect the gas lifter 100 against external shock and vibration, to set the size of the outer diameters of the inner housing 200 and the outer housing 300, and to form the gas lifter 100 to have the same outer diameter as the power lifter when mounted as a role of assisting the power lifter, thereby improving appearance.

The inner housing 200 includes a rib 210 which protrudes inward from the inner circumferential surface to be in contact with a portion of the outer circumferential surface of the cylinder 110.

The rib 210 which protrudes inward is formed on the inner circumferential surface of the inner housing 200, and the rib 210 may be in contact with the cylinder 110.

In the conventional gate opening and closing assistance device for the vehicle, a spring is inserted between the inner housing 200 and the gas lifter 100 to assist the pressure of the gate opening and closing assistance device for the vehicle with the elastic force of the spring, but the gate opening and closing assistance device for the vehicle according to the present disclosure is mounted with the power lifter and applied to serve to assist the power lifter, and does not require the elastic force of the spring, so that the spring is removed and the space into which the spring is inserted is formed as an empty space.

At this time, in order to support the gas lifter 100 in the empty space, the rib 210 may be formed in the inner housing 200 to support the movement of the gas lifter 100, and may disperse external shock, thereby protecting the gas lifter 100 from being damaged.

A plurality of ribs 210 are formed to be spaced apart from each other at regular intervals in the circumferential direction of the inner housing 200.

The plurality of ribs 210 may be protruded inward from the inner circumferential surface of the inner housing 200 and arranged with the regular intervals in the circumferential direction of the inner housing 200, thereby evenly supporting the gas lifter 100. In addition, it is possible to evenly disperse external shock, thereby protecting the gas lifter 100.

In addition, as the ribs 210 are formed to be spaced apart from each other at regular intervals when the inner housing 200 is manufactured, extrusion molding may be facilitated.

In addition, when the inner housing 200 is manufactured, the ribs 210 may be formed to be spaced apart from each other at regular intervals, thereby protecting the entire gas lifter 100 against the shocks transferred from all directions of the outer circumferential surface of the gas lifter 100.

In addition, it is advantageous in setting the size because the size of the inner housing 200 may be set constantly, and as a result, the inner housing 200 may be applied to various vehicle models, thereby decreasing the manufacturing cost.

The rib 210 is in surface contact with a portion of the outer circumferential surface of the cylinder 110.

The rib 210 protruding from the inner circumferential surface of the inner housing 200 toward the center of the inner housing 200 may have the end formed to correspond to a portion of the outer circumferential surface of the cylinder 110, so that the end of the rib 210 may be in surface contact with a portion of the outer circumferential surface of the cylinder 110.

Accordingly, the rib 210 may support the cylinder 110 more firmly, and the rib 210 of the inner housing 200 may be in surface contact with a portion of the outer circumferential surface of the cylinder 110 in a state where the cylinder rod 120 and the inner housing 200 are coupled, thereby protecting the cylinder 110 not to be shaken when the cylinder rod 120 is slid.

A first inclined portion 220 is formed on an end portion of the inner housing 200, and the first inclined portion 220 is configured to have the outer diameter gradually decreased while extending in the longitudinal direction of the inner housing.

Further referring to FIG. 7, the first inclined portion 220 is formed to extend in the longitudinal direction at one end of the inner housing 200, and formed in a shape which is inclined to have the outer diameter gradually decreased in the extending direction.

Accordingly, when the gate of the vehicle is closed, the other end of the cylinder rod 120 is located at a location corresponding to one end of the cylinder 110, and at this time, the outer circumferential surface of the first inclined portion 220 may be in contact with and fixed to the inner circumferential surface of the outer housing 300.

A second inclined portion 310 is foiled on the other end of the outer housing 300, and the second inclined portion is configured to have the inner diameter gradually decreased while longitudinally extending to correspond to the first inclined portion 220, and when the other end of the cylinder rod 120 is located at a location corresponding to one end of the cylinder 110, the outer circumferential surface of the first inclined portion 220 and the inner circumferential surface of the second inclined portion 310 are in surface contact with each other.

Further referring to FIG. 7, the second inclined portion 310 is formed to extend in the longitudinal direction from the inside of the other end of the outer housing 300, and formed in a shape which is inclined to have the inner diameter gradually decreased. At this time, the second inclined portion 310 is formed to correspond to the inclined shape of the first inclined portion 220, and when the gate of the vehicle is closed and the other end of the cylinder rod 120 is located at a location corresponding to the one end of the cylinder 110, the outer circumferential surface of the first inclined portion 220 and the inner circumferential surface of the second inclined portion 310 may be in contact with each other.

As a result, the inner housing 200 and the outer housing 300 may be firmly fixed, and it is possible to decrease noise caused by friction between the inner housing 200 and the outer housing 300 even with vibration during the traveling of the vehicle.

The entire inner circumferential surface of the inner housing 200 is in surface contact with the outer circumferential surface of the cylinder 110 on the first inclined portion 220.

Further referring to FIG. 5, in a first exemplary form of the first inclined portion 220, the inner circumferential surface of the first inclined portion 220 is formed to correspond to the outer circumferential surface of the cylinder 110 and the inner circumferential surface of the first inclined portion 220 may be in contact with the outer circumferential surface of the cylinder 110.

As a result, the inner circumferential surface of the first inclined portion 220 formed at one end of the inner housing 200 may be in surface contact with the outer circumferential surface of the cylinder 110, thereby further improving the coupling force between the cylinder 110 and the inner housing 200.

The inner housing 200 includes the rib 210 which protrudes inward from the inner circumferential surface thereof to be in contact with a portion of the outer circumferential surface of the cylinder 110, and the rib 210 has a gradually shortening length which extends and protrudes outward from the first inclined portion 220.

Further referring to FIG. 6, in a second exemplary form of the first inclined portion 220, the rib 210 formed on the inner circumferential surface of the inner housing 200 is formed to extend to the inner circumferential surface of the first inclined portion 220, and the rib 210 formed on the inner circumferential surface of the first inclined portion 220 may be in contact with the outer circumferential surface of the cylinder 110.

As a result, it is possible to manufacture the inner housing 200 to have the uniform thickness, to decrease the defect rate during manufacturing, and to improve the rigidity of the inner housing 200.

A flange portion 111, which extends in a radial direction, is formed at one end of the cylinder 110 which is exposed to the outside of the outer housing 300 through the outer housing 300.

The flange portion 111, which extends in the radial direction is formed at one end of the outer housing 300, the other end of the outer housing 300 may be coupled to the side of the flange portion 111 extending from the outer circumferential surface of the cylinder 110, and a coupling portion 130 may be coupled to the side of the flange portion 111 extending from the inner circumferential surface of the cylinder 110.

As a result, it is possible to increase the coupling force between the cylinder 110, the outer housing 300, and the coupling portion 130.

While the specific exemplary forms of the present disclosure have been illustrated and described, it will be apparent to those skilled in the art that various improvements and changes of the present disclosure are possible without departing from the technical spirit of the present disclosure.

What is claimed is:

1. A gate opening and closing assistance device for a vehicle, comprising:
a gas lifter including:
a cylinder configured to:
extend in a longitudinal direction of the gas lifter, and
be filled with a compressible material therein; and
a cylinder rod configured to:
extend in the longitudinal direction of the gas lifter, insert into the cylinder, and
slide relative to the cylinder by compression or expansion of the compressible material of the cylinder;
an inner housing configured to:
extend in the longitudinal direction,
have one end coupled to one end of the cylinder rod to be slid together according to the sliding of the cylinder rod, and
have an inner circumferential surface in contact with the cylinder while surrounding the gas lifter; and
an outer housing configured to:
extend in the longitudinal direction, surround the inner housing, and include a first end coupled to one end of the cylinder, and a second end through which the inner housing is inserted.

2. The gate opening and closing assistance device according to claim 1, wherein:
the inner housing comprises: a plurality of ribs protruding inward from the inner circumferential surface of the inner housing, and
ribs of the plurality of ribs are in contact with an outer circumferential surface of the cylinder.

3. The gate opening and closing assistance device according to claim 2,
wherein the ribs of the plurality of ribs are arranged to be spaced apart from each other at regular intervals in a circumferential direction of the inner housing.

4. The gate opening and closing assistance device according to claim 2,
wherein the ribs of the plurality of ribs are in surface contact with a portion of the outer circumferential surface of the cylinder.

5. The gate opening and closing assistance device according to claim 1,
wherein a first inclined portion is formed on an end portion of the inner housing, the first inclined portion configured to have an outer diameter gradually decreased as longitudinally extending.

6. The gate opening and closing assistance device according to claim 5,
wherein a second inclined portion is formed on an end portion of the outer housing, the second inclined portion configured to have an inner diameter gradually decreased as longitudinally extending, and
wherein when the end portion of the cylinder rod is located at a location corresponding to the one end of the cylinder, an outer circumferential surface of the first inclined portion is in surface contact with an inner circumferential surface of the second inclined portion.

7. The gate opening and closing assistance device according to claim 5,
wherein an entirety of the inner circumferential surface of the inner housing is in surface contact with an outer circumferential surface of the cylinder at the first inclined portion.

8. The gate opening and closing assistance device according to claim 5,
wherein the inner housing comprises: a rib configured to protrude inward from the inner circumferential surface thereof and be in contact with a portion of an outer circumferential surface of the cylinder, and
wherein the rib has a gradually shortening length which extends and protrudes outward from the first inclined portion.

9. The gate opening and closing assistance device according to claim 1,
wherein a flange portion which extends in a radial direction is formed on the one end of the cylinder which is exposed to outside of the outer housing through the outer housing.
